SEQUENCE LISTING (6 sequences)

SEQ ID NO: 1 - DNA, 21 bp, synthetic construct
  source 1..21: mol_type = other DNA
gcaccagtcagaccgatatgt

SEQ ID NO: 2 - DNA, 20 bp, synthetic construct
  source 1..20: mol_type = other DNA
accctgttgtcaatgcctct

SEQ ID NO: 3 - DNA, 18 bp, synthetic construct
  source 1..18: mol_type = other DNA
gtcccgctcctaaggcag

SEQ ID NO: 4 - DNA, 20 bp, synthetic construct
  source 1..20: mol_type = other DNA
gttgatcgactccagcgact

SEQ ID NO: 5 - DNA, 25 bp, synthetic construct
  source 1..25: mol_type = other DNA
aattaagcgtaactggcggaaaccc

SEQ ID NO: 6 - DNA, 25 bp, synthetic construct
  source 1..25: mol_type = other DNA
agatggtggccgcaaagaagacgaa

(19) United States
(12) Patent Application Publication
(10) Pub. No.: US 2025/0235869 A1
(43) Pub. Date: Jul. 24, 2025

(54) Thermally Conductive Microplates

(71) Applicants: BAYER AKTIENGESELLSCHAFT, Leverkusen (DE); GREINER BIO-ONE GMBH, Frickenhausen (DE)

(72) Inventors: Holger Summer, Leverkusen (DE); Ralph Noll, Leverkusen (DE); Stefan Golz, Leverkusen (DE); Bernd Kalthof, Leverkusen (DE); Jörg Hüser, Leverkusen (DE); Andreas Schade, Leverkusen (DE); Mike Küster, Leverkusen (DE); Torsten Feller, Leverkusen (DE); Andreas Nicol, Leverkusen (DE); Jochen Kuttig, Frickenhausen (DE); Günther Knebel, Frickenhausen (DE); Philipp Krohm, Frickenhausen (DE); Rainer Heller, Frickenhausen (DE)

(21) Appl. No.: 18/698,518

(22) PCT Filed: Sep. 30, 2022
(86) PCT No.: PCT/EP2022/077311

§ 371 Date: Apr. 4, 2024

(30) Foreign Application Priority Data
Oct. 6, 2021 (EP) 21201203.3

(51) Int. Cl. B01L 3/00; B29C 45/16; B29C 45/56; B29K 23/00; B29L 31/00

(52) U.S. Cl. CPC B01L 3/50851; B01L 2200/12; B01L 2300/0829; B01L 2300/16; B29C 45/16; B29C 45/561; B29K 2023/12; B29K 2023/38; B29K 2995/0013; B29L 2031/756

(57) ABSTRACT

A thermally conductive microplate made of thermoplastic material, comprising a microplate body (150) having at least 96 wells (151) arranged in the microplate body (150), the microplate body (150) having a flat microplate bottom (154), and each well (151) having at least one well wall (152) and a planar well bottom (153) which is aligned with a well bottom plane (200) shared by all well bottoms (153) and has a bottom thickness of at most 1000 μm. Also disclosed is a method for producing the thermally conductive microplates. The microplate body (150) is preferably arranged in a frame carrier (300), in particular is welded, adhesively bonded or riveted thereto. Having high thermal conductivity, upright-format thermally conductive microplates are optimised for automated processing in analysis and synthesis methods that are temperature sensitive and based on temperature change.

The present invention relates to a thermally conductive microplate and to processes for production thereof.

Microplates, also referred to as microtiter plates, are consumable laboratory material for examination of biological or/and physicochemical properties of substances, substance mixtures, chemical or biochemical systems that find use in pharmaceutical research or crop protection research in particular. Microplates are generally made from plastic and typically contain mutually isolated wells (also known as cavities) arranged in rows and columns in the form of a matrix. The dimensions of standard microplates are standardized by ANSI Standards as recommended by the Society for Laboratory Automation and Screening (ANSI/SLAS 1-2004, ANSI/SLAS 2-2004, ANSI/SLAS 3-2004, ANSI/SLAS 4-2004, and ANSI/SLAS 6-2004). Analytical and synthetic methods that are thermally sensitive and based on temperature changes, such as PCR (polymerase chain reaction, chain extension reaction) methods, thermophoresis, for example in the development of active ingredients in the pharmaceutical industry, especially microscale thermophoresis, cellular thermal shift assays (CETSA), chemical syntheses, biological assays, storage, diagnostics or microscopic FISH (fluorescence in situ hybridization), require uniform, controllable process parameters. In the course of a PCR method, genetic material is replicated, and this replication is accomplished by means of a polymerase in a number of cycles. In thermophoresis, proteins or small molecules are analyzed together with biological samples, such as proteins, under the action of temperature. In the cellular thermal shift assay (CETSA), interactions between active ingredients and target proteins are quantified.

The corresponding methods are typically performed in very small volumes in the respective wells of a microplate arranged in a thermocycler or another suitable analytical device, with implementation of the respectively desired number of cycles or method steps in a sequence of heating and/or cooling steps. The microplate enables any desired test methods, for example fluorescence and/or luminescence.

Thermally stable microtiter plates have been used for years for many reactions that are thermally sensitive and based on temperature changes (including qPCR). There are many commercially available models of microplates that have an uneven bottom or a structure. It is not possible thereby for these microplates to conduct the heat homogeneously from a heating and/or cooling hotplate. Many of these microplates have special formats and are not usable with standard devices.

Particularly the utilization of standard high-format microplates, i.e. those having a large number of wells, together with hotplates or water baths for heating and/or cooling, enables merely endpoint analyses particularly in the thermally sensitive PCR method. Thus, real-time PCR reactions in which the PCR reaction is measured or quantified after each cycle are not possible with such devices.

The performance of a reliable and precise thermal method on samples in a microplate requires precise application of process parameters in a uniform manner across the entire microplate. Thermally conductive microplates should therefore feature not only a high number of wells but also high, uniform thermal conductivity and stability. A microplate is referred to as being “thermally conductive” in the context of the invention when it enables rapid heat transfer from a hotplate into a microplate with maximum uniformity over all well bottoms.

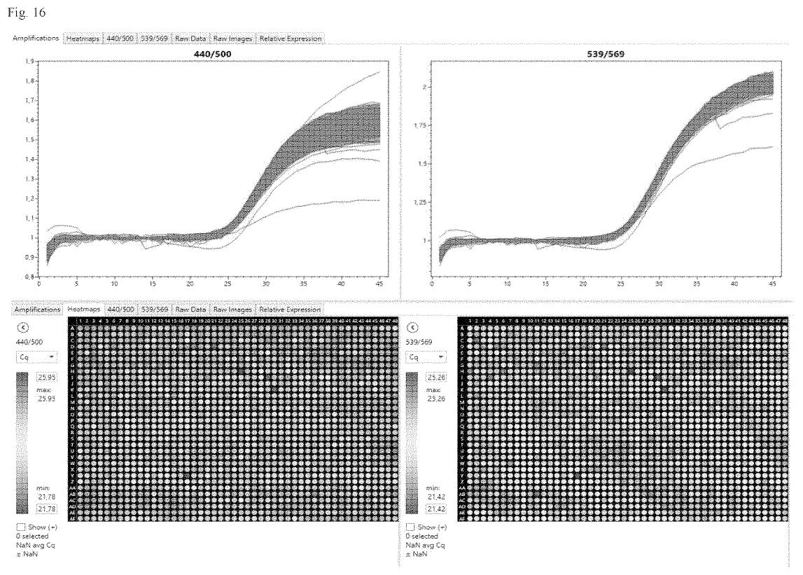

The microplates provided are intended to enable automation of handling, especially movement of the microplates in the hot state between heating blocks in a measurement device (as shown schematically, for example, in FIG. 15), maintaining the dimensional stability of the microplates as far as possible throughout the handling.

The object has been achieved by the provision of a microplate featuring a uniform bottom thickness and a high degree of flatness over all well bottoms, which are as thin as possible.

The provision of well bottoms with high flatness and uniform bottom thickness is found to be a particular challenge firstly because of the comparatively high number of wells in the given microplate format and secondly because of the thin well bottom which is needed for many applications. It is likewise challenging to provide microplates with well bottoms where the densification of the bottom material is uniform over all well bottoms.

The problem has been solved by a method of producing a thermally conductive microplate made of thermoplastic material as claimed in claim 1.

The invention further provides a thermally conductive microplate made of thermoplastic material as claimed in claim 10.

Particular embodiments will be apparent from the claims dependent on claim 1 or 10.

In the microplate of the invention, the wells are arranged in a microplate body, where the microplate body forms the well walls and well bottoms in that each well wall merges in the upward direction into a well opening and each well is closed by the well bottom on the opposite lower side of the microplate body. The microplate body forms in one piece the wells that are formed from well walls and well bottoms, with the well bottoms aligned in a well bottom plane and forming a continuous bottom element (also called microplate bottom or bottom of the microplate body).

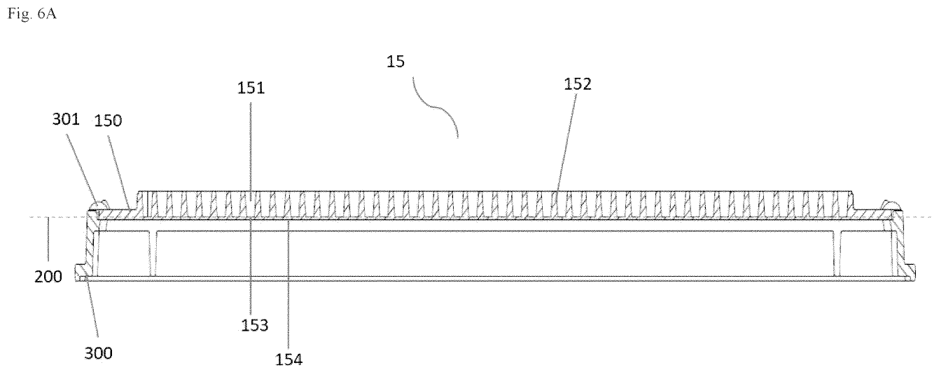

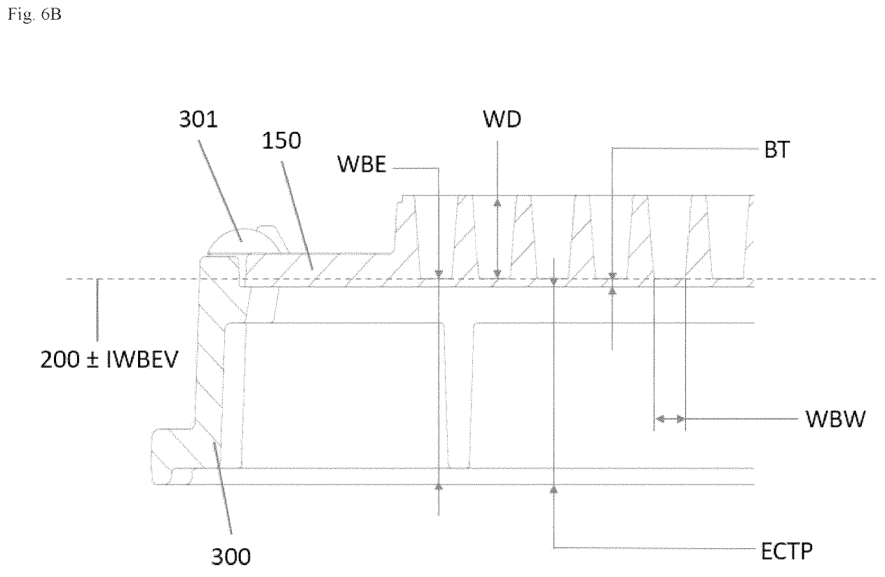

In connection with the present invention, the “bottom thickness” BT, in the context of the application, corresponds to the bottom thickness as defined in the ANSI standard from the Society for Laboratory Automation and Screening with regard to the well bottom elevation, i.e. the average thickness of all well bottoms in a single microplate, or in the present invention in a single microplate body, as shown by FIG. 6B. The bottom thickness is reported as a nominal value [ASNI_SLAS_6, https://www.slas.org/SLAS/assets/File/public/standards/ASNI_SLAS_6-WellBottomElevation.pdf].

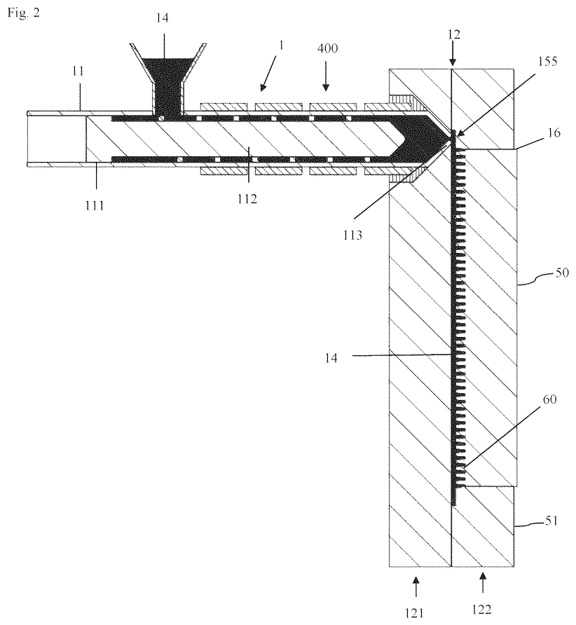

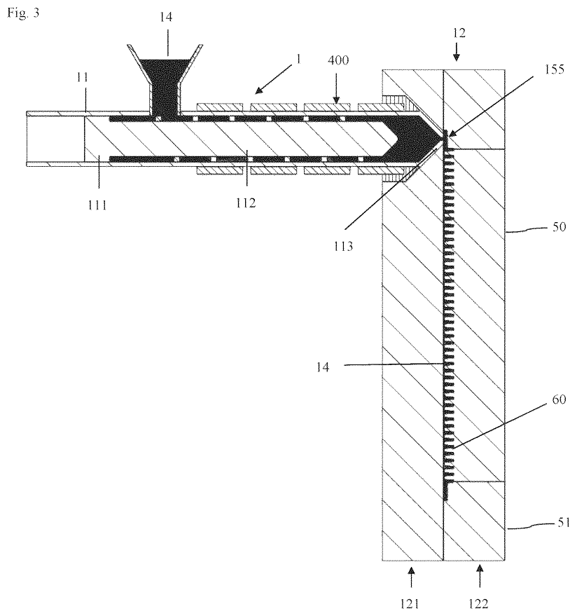

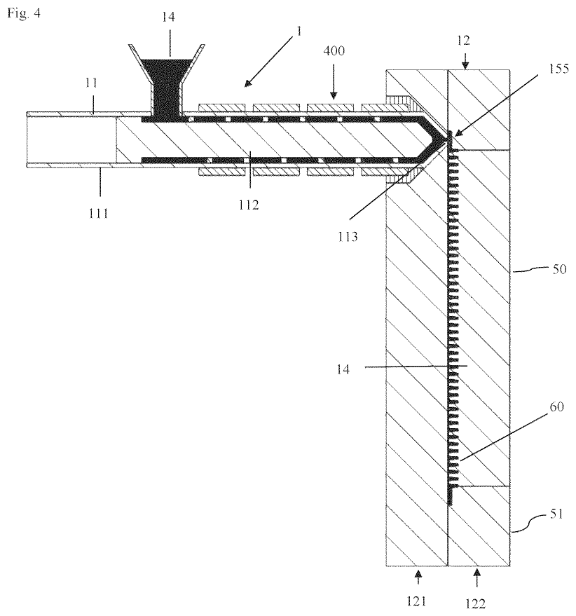

A small degree of variability of bottom thickness over the entire microplate body is crucial for uniform thermal conductivity across the microplate. This is characterized according to the ANSI standard from the Society for Laboratory Automation and Screening with regard to well bottom elevation by the following parameters:
Well Bottom Elevation Variation (WBEV) is the maximum permissible scatter between the highest and lowest WBE values in a single microplate. It is typically stated as the maximum value. (See FIG. 2. ASNI_SLAS_6-WellBottomElevation);
Intra-Well Bottom Elevation Variation (IWBEV) is the range (maximum-minimum) of the distance from the reference point-A-to any point on the inner bottom surface of a single well. It is typically reported as the maximum value (see FIG. 3 ASNI_SLAS_6-WellBottomElevation);
Well Depth (WD): Is the distance of the maximum projection of each individual well down to any point on the inner bottom surface of the well. It is typically stated as a nominal value with a tolerance (see FIG. 4 ASNI_SLAS_6-WellBottomElevation).

Thus, it is already known that plastic injection molding methods can be used for production of microplates. By means of these methods, however, it is typically impossible to establish the required low bottom thicknesses with the required flatness and uniform bottom thickness and/or uniform densification of the material.

For that reason in particular, what are called composite microplates have been developed, which have a two-part construction and are composed in particular of a frame that forms the well walls and connectors and a stiff transparent bottom element bonded or welded at one end of the end faces of the well walls (see, for example, DE 101 09 704 B4). Also known are composite microplates in which a portion that makes up the well bottom and a portion of the well wall is produced from a thermally conductive material and the frame carrier, and the remainder of the well wall from a thermally insulating material (see WO 2009/030908 A2). Such composite microplates are complex in terms of production and may have leaks.

German utility model specification DE 20 2007 003 536 U1 discloses the provision of microplates by plastic injection compression molding methods. The microplates produced by this method also have unwanted unevenness particularly in the sprue region.

The technical problem underlying the present invention is therefore that of providing thermally conductive microplates and methods for production thereof that meet the above demands, in particular thermally conductive microplates that feature a particularly high degree of flatness and uniform bottom thickness and in particular uniform densification of the material in the well bottoms, especially in all well bottoms, and hence are suitable in particular for use in PCR methods, especially qPCR and real-time PCR methods, thermophoresis methods, synthesis methods, CETSA and/or FISH methods.

For the necessary shape stability, the microplate body is arranged in, and especially welded, bonded or riveted to, a fixed frame carrier. In other words, the microplate of the invention is in two-part form.

The present invention solves the technical problem underlying it by the provision of the present teaching, especially the teaching of the independent claims and of the accompanying description.

The present invention relates to a method of producing a thermally conductive microplate from thermoplastic material, comprising a microplate body having a microplate bottom and at least 96 wells arranged in the microplate body, wherein each well is defined by a well wall and a planar well bottom, wherein the microplate bottom is flat and all well bottoms are aligned in a well bottom plane, and the microplate body between the well bottom plane and the microplate bottom has a bottom thickness of not more than 1000 μm, wherein the method comprises
a) providing liquefied thermoplastic material,
b) performing an injection compression molding step in an injection compression molding machine, comprising an injection unit having a conveying screw and an embossing die suitable for forming the thermally conductive microplate body, with introduction of a first portion of the liquefied thermoplastic material through the conveying screw into the at least partly open embossing die under a first injection pressure, closing the embossing die with exertion of a closing pressure on the thermoplastic material,
c) then performing an injection molding step with introduction of a second portion of the liquefied thermoplastic material through the conveying screw into the closed embossing die under a second injection pressure and
d) obtaining the microplate body.

The present invention also relates to a thermally conductive microplate produced or producible by the method of the invention.

The present invention also relates to a thermally conductive microplate made from thermoplastic material, comprising a microplate body having a microplate bottom and at least 96 wells arranged in the microplate body, wherein each well is defined by a well wall and a planar well bottom, wherein the microplate bottom is flat and all bowl bottoms are aligned in a well bottom plane, and the microplate body between the well bottom plane and the microplate bottom has a bottom thickness of not more than 1000 μm.

The microplate of the invention, by virtue of the combination of a thin bottom and the fixed frame carrier, is suitable for the performance of reactions that take place at different precisely set temperatures, in a device comprising multiple heating blocks connected by a transport system for rapid heating and cooling of the microplate, in that the microplate is transferred between the heating blocks. For example, these microplates may be used for the performance of quantitative polymerase chain reactions (qPCR), without being limited to this application.

In a particular embodiment, the thermally conductive microplate, or the microplate body, is producible by the following method:
a) providing liquefied thermoplastic material,
b) performing an injection compression molding step in an injection compression molding machine, comprising an injection unit having a conveying screw and an embossing die suitable for forming the microplate body, with introduction of a first portion of the liquefied thermoplastic material through the conveying screw into the at least partly open embossing die under a first injection pressure, closing the embossing die with exertion of a closing pressure on the thermoplastic material,
c) then performing an injection molding step with introduction of a second portion of the liquefied thermoplastic material through the conveying screw into the closed embossing die under a second injection pressure and
d) obtaining the microplate body.

The present invention accordingly provides the teaching of providing a thermally conductive microplate which, because of its mode of production, advantageously features a particularly high degree of flatness and/or uniform bottom thickness and/or uniform densification of the well bottom material. The thermally conductive microplates provided in accordance with the invention are notable for particularly high homogeneity with regard to the flatness of the well bottoms, the bottom thickness of the well bottoms and the densification of the material in the region of the well bottoms. This homogeneity with regard to the flatness and thickness of the well bottoms and densification of the material in the well bottoms preferably extends across the entire thermally conductive microplate, especially over the entire area of the microplate body in which well bottoms are present.

The well bottoms preferably take the form of flat bottoms. The well bottoms of all wells are collectively aligned in a planar well bottom plane, and in their totality form a planar, flat, continuous bottom element. Both the well bottoms and the well walls are an integral part of the microplate body and hence are advantageously in one-piece form and thus avoid the disadvantages associated with a two-piece well structure in the prior art. More preferably, the microplate body accordingly has a continuous bottom element that forms the bottoms of all wells, and where this bottom element has a thickness of not more than 1000 μm and is planar.

It is a particular feature of the thermally conductive microplate of the invention that the microplate body is provided in a specific 2-stage production method, especially in that it is formed by the use of an injection compression molding step in an injection compression molding machine and a subsequent injection molding step performed in the same injection compression molding machine, and this procedure provides a very flat, uniformly thick and uniformly densified well bottom.

It is a feature of the injection compression molding machine used in accordance with the invention that it has an embossing die and an injection unit in which at least one conveying screw is formed for introduction, especially injection, of the liquefied thermoplastic material into the embossing die. The embossing die is formed three-dimensionally such that it enables the forming of the desired microplate body.

Accordingly, in a first method step a), liquefied thermoplastic material is provided, of which a first portion, especially predominant first portion, is introduced, especially injected, into the partly open embossing die under a first injection pressure in a subsequent method step b) in the injection compression molding machine. The embossing die has at least two die parts that enclose and, as it were, form a cavity or hollow space, where this cavity is variable by relative movement of the at least two die parts relative to one another. In the open state of the embossing die, the at least two die parts define a comparatively large cavity into which the liquefied thermoplastic material is introduced, such that the at least two die parts can be moved relative to one another during and/or after the introduction, such that the liquefied plastic is compressed. Accordingly, the embossing die is closed after the introduction, wherein a closure pressure is exerted on the thermoplastic material present in the embossing die and the thermoplastic material is solidified. In a subsequent method step c), according to the invention, in an injection molding step under a second injection pressure, an introduction of a second portion of the liquefied thermoplastic material still present in the injection unit, especially the conveying screw, into the closed embossing die is conducted. Opening of the embossing die after method step b) is not envisaged either before or during method step c).

The second portion of the liquefied thermoplastic material is introduced into the embossing die via the conveying screw, the preferably provided injection nozzle which is arranged at the embossing die end of the conveying screw, and the corresponding receiving channel of the embossing die. The second portion of the liquefied thermoplastic material that has been introduced in this way thus arrives at the injection site of the thermoplastic material from method step b) that is already within the embossing die and thus levels out unevenness formed at this point and/or leads to uniform densification of the bottom material. It is therefore a particular feature of the microplate bodies produced in accordance with the invention that they have been produced in one piece in a two-stage method having an injection compression molding method step and an injection molding method step, and the well bottoms thereof that are formed by the bottom element have a particularly high degree of flatness. This is in particular because the injection molding method step conducted after the injection compression molding method step eliminates unevenness in the bottom element and in the well bottoms in the molding produced in method step b) by means of plastic subsequently injected in method step c). The microplate bodies thus have a very flat, uniformly thick and uniformly densified bottom element and therefore very flat well bottoms which all lie in one plane and which have a particular feature of lacking (any) function-disrupting unevenness, bulges or other artefacts around the injection site, also referred to here as the sprue. The microplate bodies have very high homogeneity, especially with regard to the thickness of the well bottoms. The high homogeneity of the flatness of the well bottoms that has been provided in accordance with the invention permits particularly high homogeneity of heat transfer, which leads to particularly reliable and precise reactions. The thermally conductive microplates of the invention are therefore especially also suitable as PCR microplates, especially qPCR microplates (quantitative PCR). In an advantageous manner, the thermally conductive microplates of the invention permit evaluation of reactions conducted in the wells thereof by means of a camera. In particular, the thermally conductive microplates of the invention permit evaluation of PCR reactions conducted in the wells thereof by means of a camera after each cycle and hence enabling of real-time PCR.

The microplate body is preferably arranged in, especially welded, bonded or riveted to, a frame carrier. This achieves better stability of the transport and handling in spite of a thin bottom.

The thermally conductive microplates of the invention are particularly suitable for automation, high-throughput screening and high-throughput diagnostics.

In a preferred embodiment, the thermally conductive microplates of the invention are PCR microplates.

It is preferable to optimize the thermal conductivity of the microplate body across the bottom thickness.

In a preferred embodiment of the present invention, the microplate body has a bottom thickness (BT) of 20 to 900 μm, especially 20 to 800 μm, especially 20 to 600 μm, especially 20 to 550 μm, especially 20 to 500 μm, especially 20 to 450 μm, especially 20 to 400 μm, especially 20 to 350 μm, especially 20 to 300 μm, especially 20 to 250 μm, especially 20 to 200 μm, especially 20 to 190 μm.

In a particularly preferred embodiment, the microplate body has a bottom thickness BT of not more than 300 μm.

The use of the production method described makes it possible to achieve a low variability (well bottom elevation variation WBEV), especially not more than 0.15 mm, over the whole area of the microplate body.

The use of the production method described makes it possible to achieve an average intra-well bottom elevation variation (IWBEV) for the microplate body of not more than ±0.05 mm.

The microplate of the invention meets the requirement of the ANSI standard from the Society for Laboratory Automation and Screening [https://www.slas.org/SLAS/assets/File/public/standards/ASNI_SLAS_6-WellBottomElevation.pdf].

The low bottom thickness enables the employment of a thermoplastic material having a thermal conductivity of 0.1 to 0.8 W/mK, measured by the method of Horst Czichos (ed.)

[Die Grundlagen der Ingenieurwissenschaften, D Werkstoffe, Wärmeleitfähigkeit von Werkstoffen [The Fundamentals of Engineering, D Materials, Thermal conductivity of materials], 31st edition, Springer, 2000, ISBN 3-540-66882-9, p. D 54.].

When they are utilized in many biological test methods, in the prior art, the microplate in the form of a disposable article sealed with a sealing film after the reactants have been introduced into the wells. The transparent thin sealing film may have been produced from polycarbonate, polypropylene, cycloolefins or other polymer materials, or from multilayer films that have been produced from two or more clear materials having desired barrier properties, as known in the prior art. The sealing can be achieved by welding of the sealing film to the body of the disposable article. Experiments have shown that the utilization of thermoplastic material containing a thermal conductivity-boosting medium makes it difficult to achieve sealing by the conventional welding method.

More preferably, the thermoplastic material does not contain any thermal conductivity-boosting medium, for example conductive carbon black or heat-conducting ceramic filler.

The required thermal conductivity is achieved by the construction of the microplate, especially by virtue of the thin bottom.

The thermoplastic material is more preferably stable at at least 120° C.

In a particularly preferred embodiment, the thermoplastic material is polypropylene and/or COC (cycloolefin copolymer) and/or polystyrene, especially polypropylene.

In a particularly preferred embodiment, the thermoplastic material does not bind any proteins and/or nucleic acids.

In a preferred embodiment, a thermoplastic material from which the microplate produced is imperviously sealable with the aid of commercially available microtiter plate sealing films or adhesive tapes is used in order to protect the contents of the wells from escape, contamination and evaporation during assay processing, incubation or storage.

In a particularly preferred embodiment of the present invention, the microplate has at least 96, preferably 384, 1536 or 3456, more preferably 1536, wells, in the formats established according to the ANSI standard from the Society for Laboratory Automation and Screening with regard to the well positions for microplates (e.g. ANSI/SLAS 4-2004—https://www.slas.org/SLAS/assets/File/public/standards/ANSI_SLAS_4-2004_WellPositions.pdf).

In a particularly preferred embodiment, the well wall has a thickness of 300 to 800 μm, especially 400 to 700 μm, especially 500 to 600 μm.

In a particularly preferred embodiment of the present invention, the wells, viewed in cross section, have a circular, square or rectangular shape.

In a particularly preferred embodiment of the present invention, the thermally conductive microplates have at least 96, especially 384, especially 1536, wells, and length and width dimensions in accordance with the ANSI standard from the Society for Laboratory

Automation and Screening (ANSI/SLAS 1-2004, ANSI/SLAS 2-2004, ANSI/SLAS 3-2004 and/or ANSI/SLAS 4-2004).

In a particularly preferred embodiment, the microplate body has a height of 1 to 8 mm, especially 2 to 5 mm, especially 3.3 mm.

In a particularly preferred embodiment, the wells each have an internal volume of not more than 10 μl, especially 0.3 to 6 μl, especially 0.5 to 4 μl, especially 4 μl or 1 μl.

In a particularly preferred embodiment, the microplate body is arranged in, and especially welded, bonded or riveted to, especially riveted to, a frame carrier. A microplate body arranged in a frame carrier together form a microplate for the purposes of the invention.

In a particularly preferred embodiment, the frame carrier is produced from polycarbonate or polystyrene.

The microplate body and/or the frame carrier may be transparent or arbitrarily opaquely colored. Especially for applications in a measurement device with visual assessment, preference is given to an opaquely colored microplate. In a particularly preferred embodiment, the thermally conductive microplate is opaquely colored black or white.

In a particularly preferred embodiment of the present invention, the frame carrier for the thermally conductive microplate of the invention together with the microplate body have the dimensions defined in the ANSI standard from the Society for Laboratory Automation and Screening [ANSI/SLAS Microplate Standards—https://www.slas.org/education/ansi-slas-microplate-standards/; ANSI SLAS 1-2004 (R2012): Footprint Dimensions, ANSI SLAS 2-2004 (R2012): Height Dimensions, ANSI SLAS 3-2004 (R2012): Bottom Outside Flange Dimensions, ANSI SLAS 4-2004 (R2012): Well Positions, ANSI SLAS 6-2012: Well Bottom Elevation].

In a particularly preferred embodiment of the present invention, the thermally conductive microplates have length and width dimensions in accordance with the ANSI standard from the Society for Laboratory Automation and Screening (ANSI/SLAS 1-2004, ANSI/SLAS 2-2004, ANSI/SLAS 3-2004 and/or ANSI/SLAS 4-2004), especially length 127.76 mm×width 85.48 mm.

In a particularly preferred embodiment, the frame carrier of the thermally conductive microplates of the invention has a height of 10.4 mm.

In a particularly preferred version of the present invention, the frame carrier is rectangular.

The microplate of the invention may be provided by the production method of the invention. In the method of the invention, in step b), an injection compression molding step is performed in an injection compression molding machine, with introduction of a first portion of the liquefied thermoplastic material through the conveying screw into the at least partly open embossing die under a first injection pressure, closing the embossing die with exertion of a closing pressure on the thermoplastic material.

In the context of the invention, what is meant by “at least partly open embossing die” in step b) is preferably an offset in the embossing die which is caused by opening (FIG. 2); experience has shown that the optimal offset is 0.1 to 0.8 mm, preferably 0.3 to 0.6 mm, preferably 0.5 mm, but this is preferably ascertained or confirmed experimentally.

In a particularly preferred embodiment of the method, the first injection pressure provided in method step b) is higher than the second injection pressure provided in method step c).

In a further preferred embodiment, the first injection pressure provided in method step b), especially the higher first injection pressure provided in method step b) and the second injection pressure provided in method step c), is exerted over a shorter period of time than the second injection pressure provided in method step c).

In a particularly preferred embodiment, the first injection pressure is 700 to 1100, especially 750 to 1000, especially 750 to 950, especially 750 to 900 and especially 900 bar.

In a particularly preferred embodiment, the first injection pressure is exerted over a period of 0.1 to 10, especially 0.1 to 9, especially 0.1 to 5, especially 0.1 to 2 and especially 0.25 seconds.

In a particularly preferred embodiment, the first portion of the liquefied thermoplastic material is introduced into the embossing die in method step b) at a speed of 100 mm/second.

In a particularly preferred embodiment, the second injection pressure is 200 to 700, especially 250 to 700, especially 300 to 700 and especially 500 bar.

In a particularly preferred embodiment, the second injection pressure is exerted over a period of 10 to 30, especially 11 to 30, especially 12 to 28 and especially 14 to 25 seconds.

In a particularly preferred embodiment, a method of producing a thermally conductive microplate of the invention is provided, wherein the injection molding step envisaged in method step c) is conducted in two phases, especially in at least two phases with different injection pressures, especially with a first second and a second second injection pressure. In this embodiment, the first second injection pressure is greater than the second second injection pressure, especially twice as high. The first second injection pressure, which is greater than the second injection pressure in a preferred embodiment, is preferably exerted over a period of 4 to 13 seconds, especially 7 to 11 seconds, especially 9 seconds, and the second injection pressure is preferably exerted over a period of 2 to 8 seconds, especially 4 to 6 seconds, especially 5 seconds, where the sum total of the periods is preferably 10 to 30 seconds, especially 12 to 28 and especially 14 to 25 seconds.

In a particularly preferred embodiment of the method, the closure pressure is 600 to 1000, especially 700 to 900 and especially 800 kN.

In a particularly preferred embodiment, a method of producing a thermally conductive microplate of the invention is provided, where the closure pressure is maintained until the opening of the embossing die to obtain a thermally conductive microplate, especially over the period of method step c).

In a particularly preferred embodiment, a method of producing a thermally conductive microplate of the invention is provided, wherein the thermoplastic material is stable at at least 120° C.

In a particularly preferred embodiment, a method of producing a thermally conductive microplate of the invention is provided, wherein the thermoplastic material is polypropylene and/or cycloolefin polymer (COP) and/or COC (cycloolefin copolymer) and/or polystyrene, especially polypropylene.

In a particularly preferred embodiment of the present invention, a method of producing a thermally conductive microplate of the invention is provided, wherein the mass of the first portion of the liquefied thermoplastic material is greater than the mass of the second portion of the liquefied thermoplastic material.

In a particularly preferred embodiment of the present invention, a method of producing a thermally conductive microplate of the invention is provided, wherein—based on the total mass of liquefied thermoplastic material introduced in method steps b) and c)—40% to 90%, especially 50% to 80% and especially 60% to 70% by weight is introduced as the first portion and 10% to 60%, especially 20% to 50% and especially 30% to 40% by weight as the second portion of the thermoplastic material.

In a particularly preferred embodiment, the first portion of the liquefied thermoplastic material introduced according to method step b) is 50% to 80% and especially 60% to 70% by weight, and the second portion of the liquefied thermoplastic material introduced according to method step c) is 20% to 50%, especially 30% to 40% by weight (based in each case on the total mass of thermoplastic material introduced).In a particularly preferred embodiment, a method of producing a thermally conductive microplate of the invention is provided, wherein the mass ratio of the first portion of the liquefied thermoplastic material to the second portion of the liquefied thermoplastic material is from 0.5 to 2.5, especially 1 to 2, especially 2 first portion to 1 second portion.

In a particularly preferred embodiment of the present invention, the method in method step b) is conducted as a gating method, especially a needle valve gating method.

In a particularly preferred embodiment of the present invention, the method in method step c) is conducted as a gating method, especially a needle valve gating method.

In a particularly preferred embodiment of the present invention, the method in method steps b) and c) is conducted as a gating method, especially a needle valve gating method.

In a particularly preferred embodiment of the present invention, the injection compression molding machine used in accordance with the invention comprises at least one injection unit and at least one embossing die, where the injection unit especially includes at least one plastifying cylinder and a rotatable conveying screw, and where there is an injection nozzle that constitutes the transition to the embossing die at the end of the conveying screw facing the embossing die. The injection unit and embossing die are temperature-controllable, especially temperature-guided, and may have different temperatures.

In a particularly preferred embodiment of the present invention, the embossing die used in accordance with the invention comprises at least two die parts that define a cavity for formation of the thermally conductive microplate of the invention with variable volume, where a first die part defines the bottom area of the thermally conductive microplate and the second die part is movable relative to the first die part, especially in the normal direction thereof, and has a multitude of embossing core elements corresponding to the number of wells.

In connection with the present invention, a “sprue” is understood to mean the place in the microplate body where the injection nozzle of the injection compression molding machine introduces the liquefied thermoplastic material into the embossing die.

In connection with the present invention, a “sink mark” is understood to mean a depression in a microplate body that leads to a reduced bottom thickness, densification and/or unevenness especially in the region of the well bottom.

In connection with the present invention, “thermally conductive” is understood to mean the property of a material of conducting heat within the material without occurrence of mass transfer.

In connection with present invention, the expression “and/or” is understood to mean that all members of a group associated by the expression “and/or” are expressed both cumulatively together in any combination and as alternatives to one another. By way of example, the expression “A, B and/or C” means the following disclosure content: i) (A or B or C), or ii) (A and B), or iii) (A and C), or iv) (B and C), or v) (A and B and C), or vi) (A and B or C), or vii) (A or B and C), or viii) (A and C or B).

Further preferred embodiments of the present invention are subjects of the dependent claims.

### LIST OF REFERENCE NUMERALS

1 injection compression molding machine
11 injection unit
111 plastifying cylinder
112 conveying screw
113 injection nozzle
12 embossing die
121/122 die parts
13 cavity/volume
14 thermoplastic material/melt
15 thermally conductive microplate
150 microplate body
151 well
152 well walls
153 well bottom
154 bottom element/bottom of the microplate body/microplate bottom
155 sprue
16 opening-related offset in embossing die
50 middle element of the die part 122 having embossing core elements
51 edge element of the die part 122
60 embossing core element
200 well bottom plane
300 frame carrier
301 rivet
WBE—WELL BOTTOM ELEVATION
WD—WELL DEPTH
ECTP—EXTERNAL CLEARANCE TO PLATE BOTTOM
WBW—WELL BOTTOM WIDTH
BT—BOTTOM THICKNESS
IWBEV—Intra-Well Bottom Elevation Variation
400 heating elements for melting the plastic
500 hotplate
501 cover plate
600/600′ camera
601 illumination

The invention is elucidated in detail by the examples that follow and the corresponding figures,

in which:

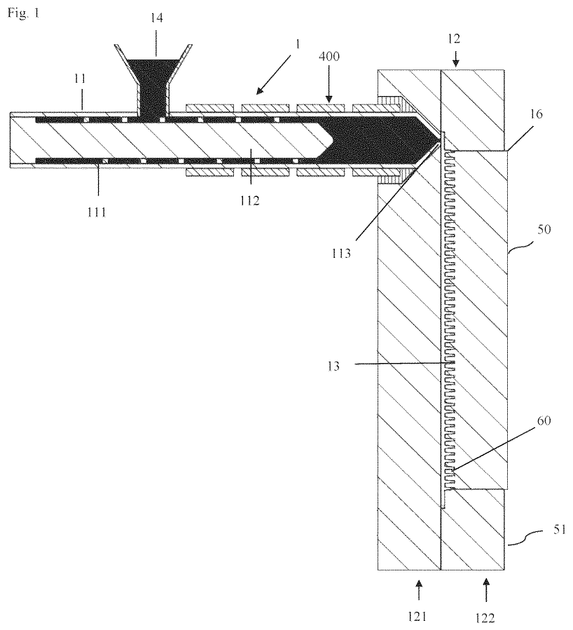

FIG. 1 shows the injection compression molding machine (1) with injection unit (11) and embossing die (12), with the unmolten thermoplastic material (14) in the injection unit. The conveying screw (112) is in the starting position and the embossing die is in a slightly open state, which can be seen from the offset (16) between a middle element (50) having embossing core elements (60) that are movable in relative terms, and an edge element (51) of the die part (122), which define the volume (13) formed by the well walls.

FIG. 2 shows the injection compression molding machine (1), wherein the thermoplastic material (14) is injected via the injection nozzle (113) into the cavity (13) of the embossing die (12) with a first injection pressure. The conveying screw moves here toward the injection nozzle. The thermoplastic material (14) has been melted (plastified) by heating and friction in the region of the heating elements (400) of the conveying screw.

FIG. 3 the injection compression molding machine (1), wherein the embossing die (12) is closed and a closing pressure is exerted. This can be seen from the movement of the middle element (50) of the die part (122) that defines the volume formed by the well walls relative to the edge element (51) of the die part (122).

FIG. 4 shows the injection compression molding machine (1), wherein the conveying screw (112) introduces further thermoplastic material (14) into the closed embossing die (12), with exertion of a second injection pressure.

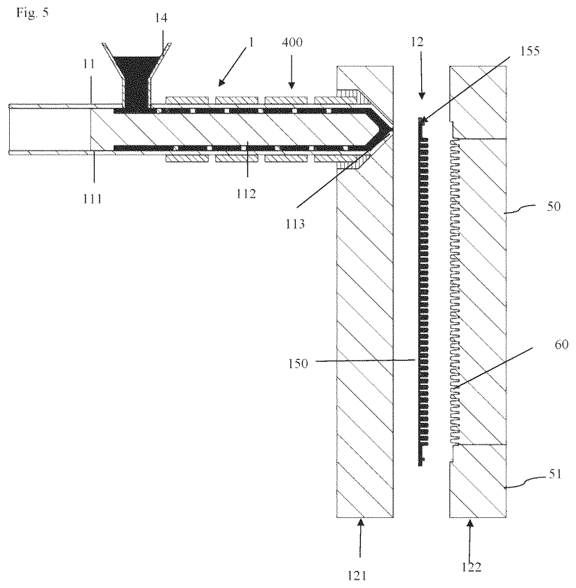

FIG. 5 shows the obtaining of the microplate body (150) by opening the embossing die (12).

FIG. 6A a schematic diagram of a microplate (15) in side view with microplate bodies (150) arranged in a frame carrier (300).

FIG. 6B shows an enlarged section of FIG. 6A with specification of the main quality parameters of a microplate (15) of the invention.

FIG. 7 shows a 3D scan of the surface of a microplate body (150) in which, in the region of the sprue (155), there is no sink mark, and therefore no depressions that lead to reduced bottom thickness, densification or unevenness in the well bottom, and the bottom is particularly flat compared to a noninventive microplate having depressions that lead to reduced bottom thickness, densification or unevenness in the well bottom.

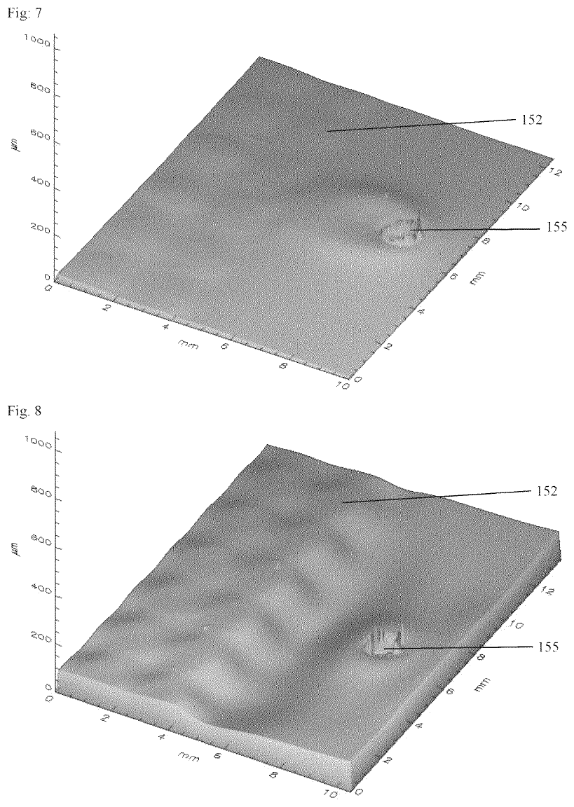

FIG. 8 shows a 3D scan of the surface of a microplate not produced in accordance with the invention (injection compression molding method), in which there is a sink mark in the region of the sprue (155) and the bottom is not flat compared to a thermally conductive microplate body of the invention.

FIG. 9 shows a photo of the surface of a microplate body (150) produced in accordance with the invention, in which there is no apparent sink mark in the region of the sprue (155) and the bottom is particularly flat compared to a microplate not produced in accordance with the invention.

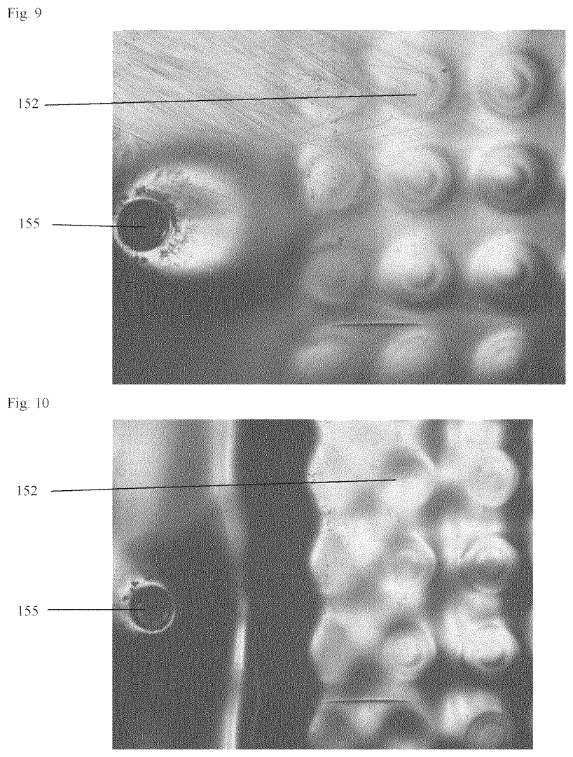

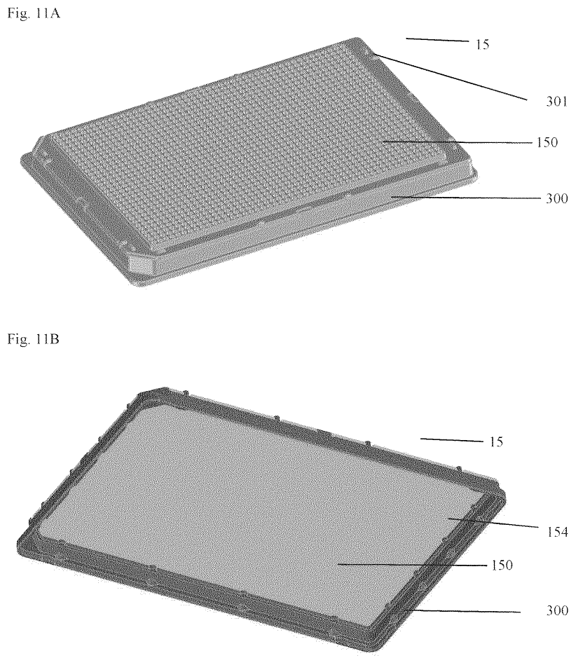

FIG. 10 shows a photo of the surface of a microplate not produced in accordance with the invention (injection compression molding method), in which there is a visible sink mark (155) in the region of the sprue and the bottom is not flat compared to a microplate body (150) produced in accordance with the invention.

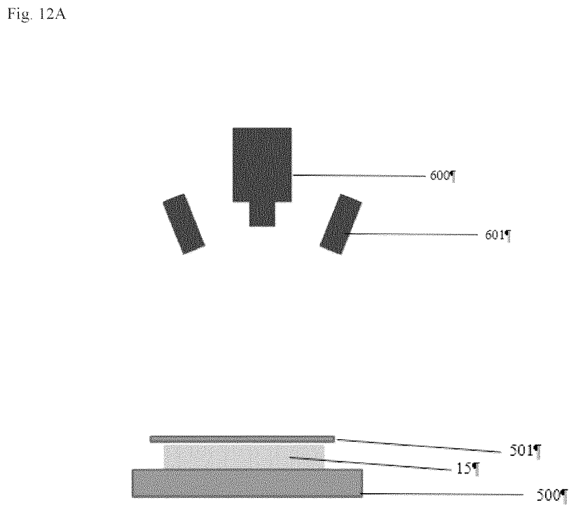

FIGS. 11A and 11B show 3D views obliquely from the top and obliquely from the bottom of a thermally conductive microplate (15) of the invention with 1536 wells (151), where the microplate body (150) is riveted in a frame carrier 300.

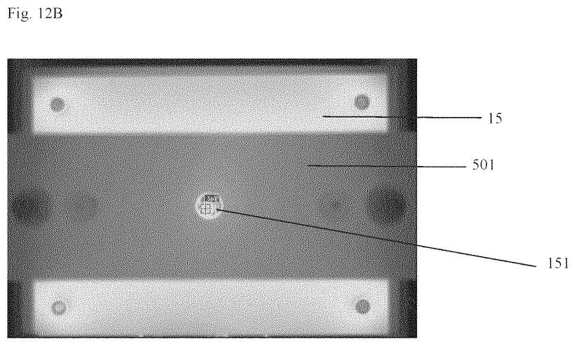

FIG. 12A shows the structure in the cross section of a thermographic experiment with the microplate of the invention.

FIG. 12B shows an image of the experimental setup taken from the top with the FLIR 645 sc (LWIR) thermography camera, where position SP1 indicates a well in the microplate.

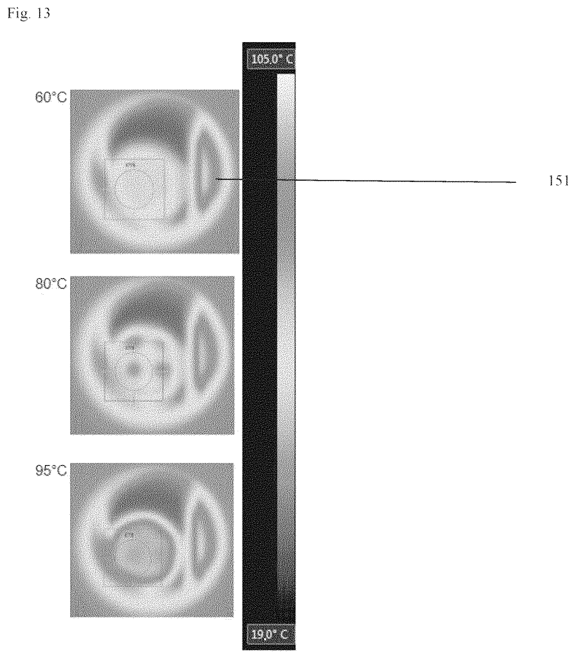

FIG. 13 shows a detail image of the measurement conducted in the well (151) at different temperatures of 60° C., 80° C. and 95° C., and a color scale for comparison.

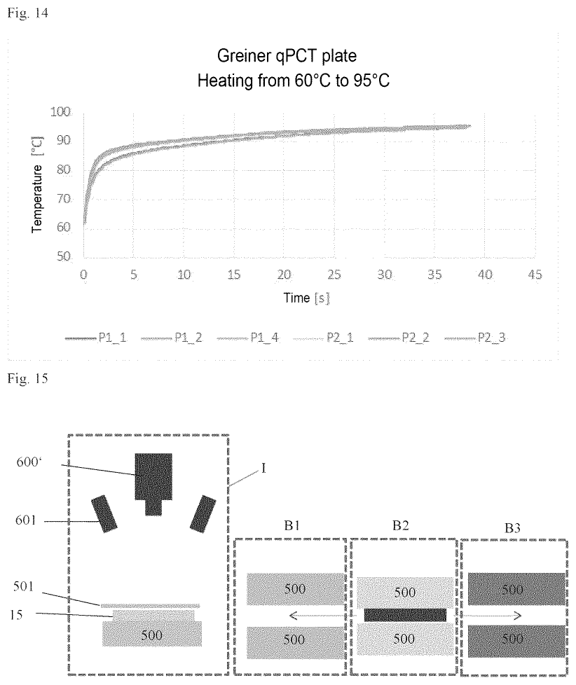

FIG. 14 shows the heating curve of the microplate (15) of the invention in the course of heating from 60° C. to 95° C. over time and the reproductivity thereof.

FIG. 15 shows a schematic diagram such a measurement device comprising 3 PCR blocks B1 to B3 for rapid heating and cooling of the microplate.

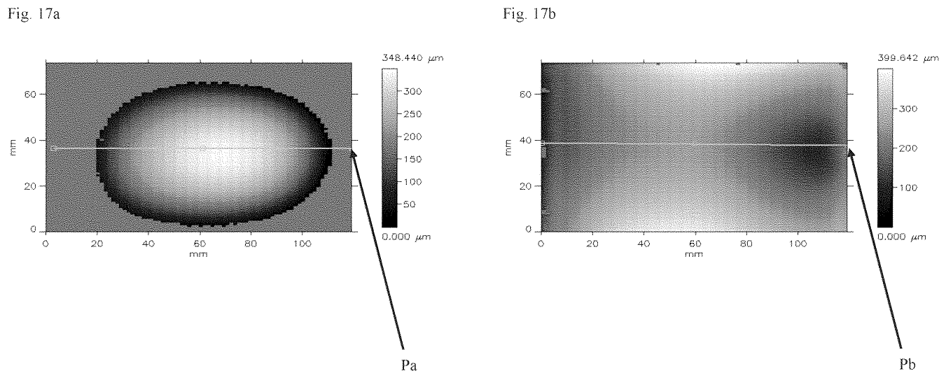

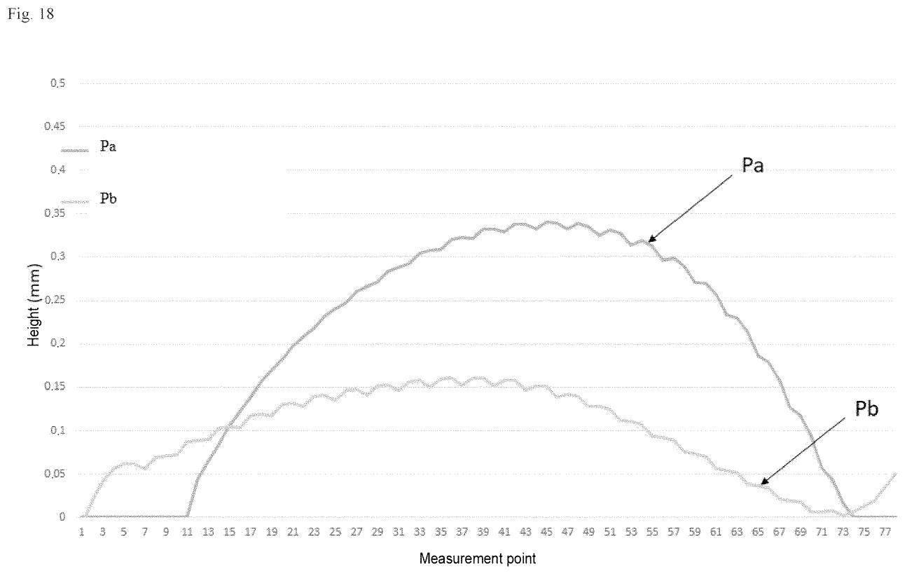

FIG. 16 shows a plot of a measurement recorded with an sCMOS camera with a 35 mm F1.6 C-mount objective that shows homogeneous amplification across the entire plate. FIGS. 17a and 17b and 18 show topographic measurements via white light interferometry for the plates produced by the injection compression molding method, and by the described method of the invention. FIGS. 17a, 17b show images of the interference signal via the CCD sensor of the measurement device.

FIG. 18 shows the respective bulges of the plates at various measurement points on the profiles Pa and Pb.

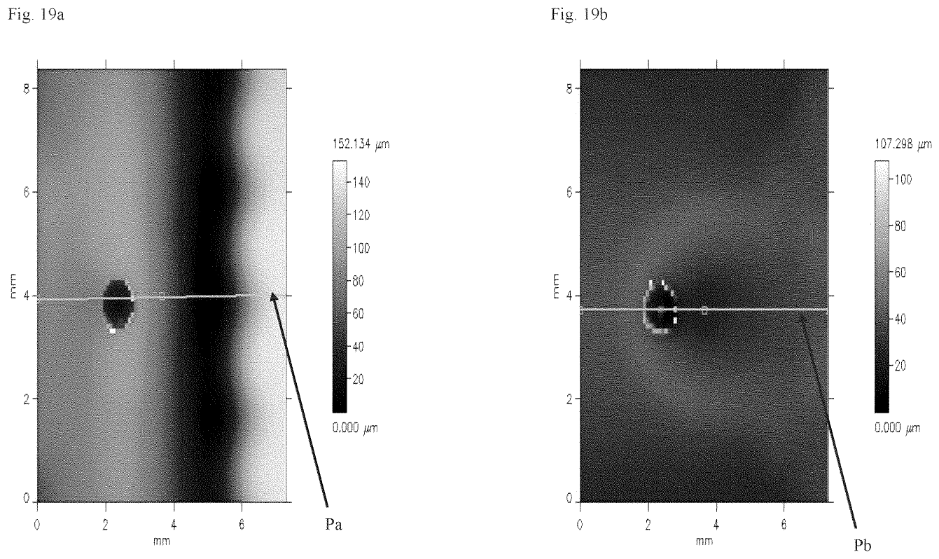

FIG. 19a and FIG. 19b show white light interferometry around the injection site, in each case for plates produced by the injection compression molding method or by the described method of the invention.

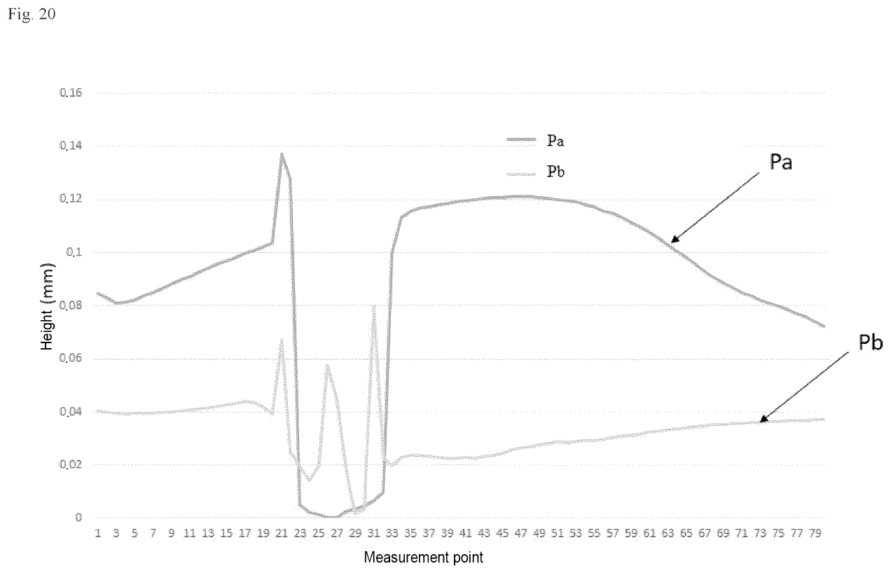

FIG. 20 shows the corresponding bulges at the injection site.

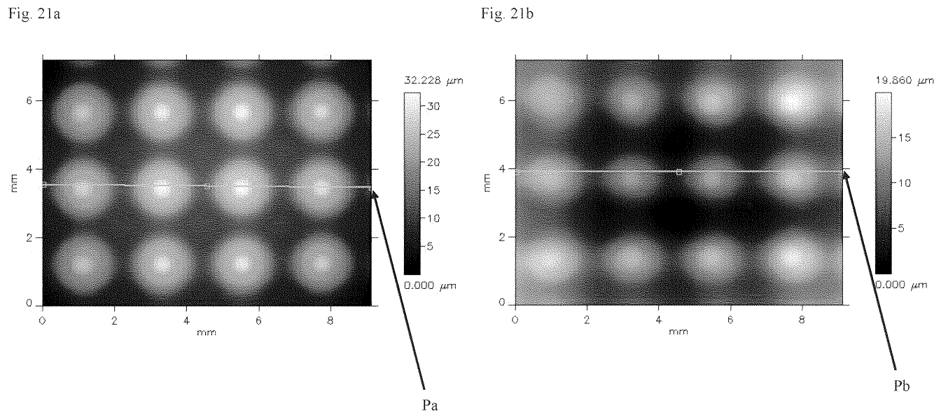

FIG. 21a and FIG. 21b show white light interferometry of the flatness within the wells, in each case for plates produced by the injection compression molding method or by the described method of the invention.

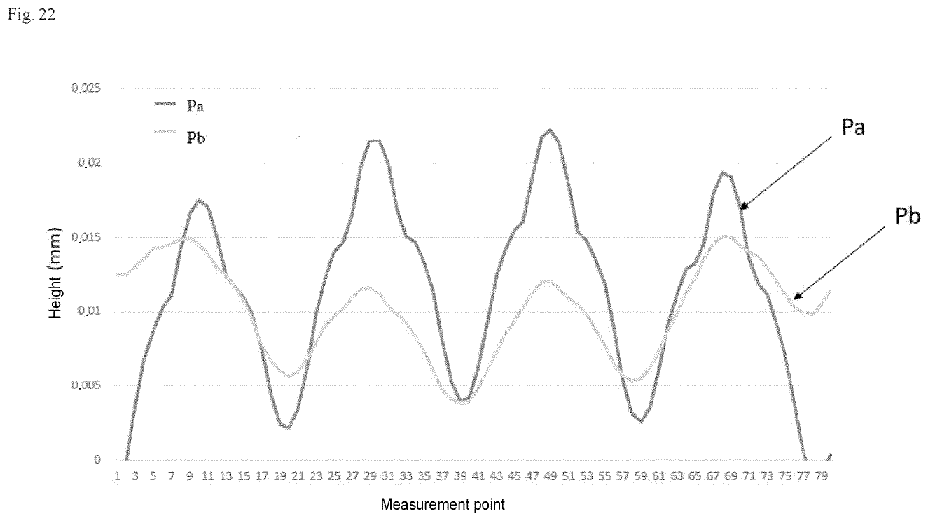

FIG. 22 shows corresponding profile measurements of flatness within the wells.

### EXAMPLE

The method of producing a thermally conductive microplate (15) described below is conducted in an injection compression molding machine (1) comprising an injection unit (11), where the injection unit comprises a rotatable conveying screw (112) in a plastifying cylinder (111) provided with heating elements (400), where there is an injection nozzle (113) at the end of the conveying screw facing the embossing die (12). The injection compression molding machine additionally has an embossing die (12) formed from at least two die parts (121/122), where the two die parts are movable relative to one another and form a cavity (13) into which the liquefied thermoplastic material (14) is introduced and forms the thermally conductive microplate therein. One of the die parts (121) defines the bottoms of the wells, while another die part defines the volume (122) formed by the well walls (see also construction of the injection compression molding machine in FIG. 1).

The method of the invention is described and elucidated in detail hereinafter with reference to the appended drawings and illustrative specified settings.

The use of all examples or illustrative wordings (e.g. “such as”) that are provided herein is merely intended to better elucidate the invention and does not restrict the scope of the invention, unless stated otherwise.

The invention encompasses all modifications and equivalents of the subject matter that are detailed in the enclosed claims, to the extent permissible under current law. In addition, any combination of the elements described above in all possible variations thereof is encompassed by the invention, unless specified otherwise herein or clearly contradicted by the context.

In a first method step a), polypropylene was provided in liquefied form as a melt (14). In a second method step b), the embossing die (12) was provided in a semi-open state (FIG. 1); the embossing die was open by 0.5 mm and a first portion of the liquefied polypropylene, namely 15 g (67% by weight or about 2 times the first portion) was introduced into the cavity (13) of the embossing die via the conveying screw (112)—which moves over 87% of the distance toward the injection nozzle required for injection—with a first injection pressure of 900 bar over a period of 0.25 second (FIG. 2), the embossing die was closed and a closure pressure of 800 KN was exerted (FIG. 3). In a subsequent method step c), a two-phase injection molding step was performed with a first second injection pressure of 500 bar over a period of 9 seconds and then with a second second injection pressure of 250 bar over a period of 5 seconds, i.e. for 14 seconds in total, where a second portion of liquefied polypropylene, namely 7.5 g (33% by weight), was introduced by the conveying screw into the closed embossing die (in the closed state the embossing die was open by 0.3 mm), where the conveying screw moves over the remaining 13% of the distance required for injection (FIG. 4). After solidification of the liquefied polypropylene, the embossing die was opened and, in a method step d), the microplate body (150) for the thermally conductive microplate (15) of the invention was obtained (FIG. 5). The microplate body (150) produced was fixed by means of rivets (301) in a frame carrier (300) manufactured from polycarbonate.

The microplates produced collectively have the following features: number of wells: 1536 wells; WBE=7.4 mm; WD=3 mm; WBW=1.2 mm; BT=0.3 mm; ECTP=7.1 mm; microplate body material: polypropylene; frame carrier material: polycarbonate.

FIG. 6A shows a thermally conductive microplate (15) obtained in accordance with the invention. This shows the wells (151) that are arranged in a microplate body (150) and have well walls (152), the individual well bottoms (153) of which lie in a well bottom plane (200) formed, where the microplate bottom (154) is flat. Each well is formed from a circular well wall (152), viewed in cross section, which opens in the upward direction in a well opening and is closed and bounded on the opposite lower side by the planar well bottom (153). The microplate body (150) is fixed by rivets (301) in the frame carrier (300). FIG. 6B shows an enlarged section of FIG. 6A with specification of the main quality parameters of a microplate (15) of the invention. Surface measurements on the overall plate or a plate section from the bottom by means of a surface measurement device with a confocal distance sensor for determination of high profiles by individual measurement lines show that injection compression molding leads to bending of the plate <0.1 mm. This low degree of bending was not achieved in the case of microplate specimens by standard production methods (bending >0.3 mm).

For the evaluation of the bending of individual wells, a plate section from the bottom was analyzed. The measurements showed that injection compression molding led to a uniform bottom structure of the plate with variance <10 μm. This uniformity and flatness was not achieved in the case of microplate specimens by standard production methods (variances >14 μm).

FIGS. 7 to 10 show the benefits of the method of the invention for production of the microplate by comparison with microplates produced by a conventional injection compression molding method.

The thermally conductive microplate (15) of the invention also had a particularly flat microplate bottom (154), apparent in particular in the region of the sprue (155) in FIG. 7 (microplate of the invention) as a circle with a dark interior-by comparison with a by standard production methods microplate in FIG. 8. In the region between the sprue and the wells of the microplate, a sink mark that causes unevenness is apparent in the noninventive microplates in the form of a depression (compare FIG. 7 with FIG. 8, especially the region between 4 and 6 mm (x axis), and FIG. 9 with FIG. 10, especially the region to the right of the sprue, the darker region).

The procedure of the invention for production of a thermally conductive microplate therefore leads to particularly marked flatness of the bottom (154/153) and particularly uniform bottom thickness of the thermally conductive microplate (15). FIG. 11A and FIG. 11B show a 3D view obliquely from the top and from the bottom of a thermally conductive microplate (15) of the invention, riveted in a frame carrier (300), where this microplate has 1536 wells (151).

In a further experiment, an inventive microplate (15) with empty wells was placed onto a hotplate (500) and covered with an opaque cover plate (501) with the exception of one well (151/sp1), and a thermography camera (600), e.g. FLIR 645 sc (LWIR), and a light source (601) were used to record and measure the change in temperature at the well bottom (153). FIG. 12A shows the structure of the thermography experiment in cross section.

FIG. 12B shows an image of the experimental setup taken from the top with the FLIR 645 sc (LWIR) thermography camera, where position SP1 indicates a well in the microplate.

FIG. 13 shows a detail image of the measurement conducted in the well (151) at different temperatures of 60° C., 80° C. and 95° C., and a color scale for comparison.

FIG. 14 shows the heating curve of the microplate (15) of the invention in the course of heating from 60° C. to 95° C. over time and the reproductivity thereof. The rise in the case of a temperature jump of nominally 35 K was 20 K in about 2 s. This thermal experiment shows that rapid heat transfer from the hotplate into the microplate is achieved.

In addition, the employability of the microplate of the invention for real-time PCR was tested experimentally.

In a white microplate of the invention with 1536 wells, for example, the following steps were conducted:

For each well of the microplate (15), a mixture of the following solution was used and pipetted into the wells (151):

| Solution | per cavity |
|---|---|
| UltraPlex ™ 1-Step ToughMix ® | 0.25 μl |
| (4X)-Quantabio | |
| qPCR Human Reference cDNA, | 0.05 ng |
| random-primed (TaKaRa Bio 639654) | |
| RPL32 primer/sample mixture (1.33 | 0.25 μl |
| μM for each primer or sample) | |
| PCR-suitable water | add |
| | 1 μl |

Subsequently, the microplate (15) was sealed with a visually clear, permanently tacky film (Applied Biosystems, 4311971) (not shown), and the microplate (15) was centrifuged and placed into a measuring device for real-time PCR measurements (also called PC measuring device).

FIG. 15 shows a schematic diagram such a measurement device comprising 3 PCR blocks B1 to B3 for rapid heating or cooling of the microplate according to a procedural protocol with heating blocks (500) and an imaging station I comprising a heating block (500) and a transparent hotplate (501) for controlling the temperature of the microplate (15), and a light source (401) and an sCMOS camera with a 35 mm F1.6 C-mount objective (600′). The microplate (15), with the aid of a transport system, illustrated schematically by horizontal arrows, is moved between the PCR blocks B1 to B3 (the numbering is arbitrary) and the imaging station I according to the procedural protocol.

The following procedural protocol was used in the PCR measurement device: An initial time of 2 min at 95° C. is followed by a cycle of 3 temperature steps with in each case firstly 10 seconds at 95° C., secondly 30 seconds at 60° C. and thirdly 5 seconds at 72° C. This cycle is repeated 45 times. In each cycle, after the third step (72° C.), the plate is irradiated/excited with light of wavelength 539 nm, and the light which is then emitted is recorded/measured at 569 nm.

Overview of the primers/samples used for the PCR reaction:

| Identifier | Gene | Sequence |
|---|---|---|
| 539/569: | | |
| RPL32_forward | RPL32 | 5′-GCACCAGTCAGACCGATATGT-3′ |
| RPL32 reverse | RPL32 | 5′-ACCCTGTTGTCAATGCCTCT-3′ |
| RPL32_sample (5′ | RPL32 | 5′-AATTAAGCGTAACTGGCGGAAACCC-3′ |
| labeled with the | | |
| fluorophore HEX and | | |
| 3′ labeled with the | | |
| quencher BHQ1) | | |
| 440/500: | | |
| RPL30_forward | | 5′-GTCCCGCTCCTAAGGCAG-3′ |
| RPL30 reverse | | 5′-GTTGATCGACTCCAGCGACT-3′ |
| RPL30_sample | | 5′-AGATGGTGGCCGCAAAGAAGACGAA-3′ |
| (5′ labeled with the | | |
| fluorophore Cyan500 | | |
| and 3′ labeled with the | | |
| quencher BHQ1) | | |

FIG. 16 shows a plot of a measurement recorded with an sCMOS camera with a 35 mm F1.6 C-mount objective that shows homogeneous amplification across the entire plate.

The homogeneous distribution of temperature across the whole plate shows the benefit of the production method, especially in the region of the sprue.

Further comparisons of 1536-well plate bodies that have been produced by different production methods:

A comparison was made of 1536-well plate bodies produced by conventional injection compression molding, standard injection molding, and the method of the invention with the aid of the mold from FIG. 1.

For all production processes, polypropylene was provided in liquefied form as a melt. The melt was introduced into the cavity (13) of the mold/compression die with the parameters detailed below. After the liquefied polypropylene had solidified, the embossing die was opened and the microplate body was obtained.

For the injection compression molding of the plate body, the melt was introduced into the cavity (13) of the incompletely closed embossing die with the following parameters: holding force of 950 kN, injection time of 0.3 s, changeover point of 10.61 mm and injection speed of 106.1 mm/s.

For standard injection molding, the melt is introduced into a mold suitable for the purpose with similar parameters. Experience has shown, however, that the achievable bottom thickness of such plates is at least 0.6 mm; such plates are unsuitable for qPCR experiments because of their inadequate heat transfer.

The plate of the invention was provided by the method described above.

Topographic measurements of the underside of the respective plate bodies were conducted with the aid of a white light interferometer at room temperature. White light interferometry is a contactless optical test method that exploits the interference of broadband light (white light) and hence permits 3D profile measurements of structures with dimensions between a few centimeters and a few micrometers. White light interferometry is frequently used for analysis (quality testing) of wafers.

Each of the measurement objects was placed into the white light interferometer and measured.

The effective area in white light interferometry was about 80 mm×120 mm.

FIGS. 17a and 17b, depending on the position of the measurement object for each individual pixel, show an interference signal obtained by the CCD sensor of the measurement device. FIG. 18 shows the respective curvature of the plates at different points on the respective reference profiles Pa and Pb, derived by the method from the prior art based on the measured values for the respective pixel.

The plate produced by the conventional injection compression molding method shows an interference signal partly outside the measurement region (gray region, FIG. 17a). The plate shows a general curvature of about 0.35 mm in the measurable region (FIG. 18, profile Pa).

All interference signals of the plate produced by the method of the invention are within the measurement range (FIG. 17b); this plate shows improved flatness of about 0.15 mm (FIG. 18, profile Pb).

Flatness and curvature can even be improved further by compression of the two-part plate 15 between two hotplates 500, 501) during utilization at a temperature of 95° C. in a device according to FIG. 5.

Low plate warpage is indispensable for the qPCR process since it enables reliably close contact between plate bottom and heat source.

### Measurements Relating to the Sink Mark at the Injection Site

FIG. 19a and FIG. 19b show white light interferometry measurement around the injection site, in each case for plates produced by the injection compression molding method or by the method of the invention. FIG. 20 shows the corresponding profiles at the injection site for the respective positions Pa and Pb.

For white light interferometry measurement from the underside of the plate around the injection site (FIGS. 19a, 19b), an effective area of 8 mm×8 mm was defined. For reliable qPCR results, all wells must show comparable power. The significant sink marks at the injection site within the qPCR plate produced by conventional injection molding lead to nonuniform contact between the underside of the plate and the heat source. The result is incorrect or at least retarded signal strength in qPCR.

### Measurements of Flatness Within the Wells

FIG. 21a and FIG. 21b show white light interferometry measurements of the flatness within the wells, in each case for plates produced by the injection compression molding method or by the method of the invention. FIG. 22 shows the corresponding profile measurements of flatness within the wells, for the respective reference profiles Pa and Pb.

For the measurement, a 7 mm×9 mm section was measured from the plate bottom of each plate. FIG. 21a and FIG. 21b show the white light interferometry measurements of the plates measured.

The well bottom in the plate that was produced by the method of the invention, with a variance of below 10 μm, is flatter than the well bottom of the plate produced by the conventional injection compression molding method.

For reliable qPCR results, all wells must show comparable power. The marked variance of the well bottom in the case of plates produced by conventional injection compression leads to nonuniform heat transfer between plate and heat source. The result is incorrect or at least retarded signal strength in qPCR.

1. A method of producing a thermally conductive microplate from thermoplastic material, comprising a microplate body having at least 96 wells arranged in the microplate body, wherein the microplate body has a flat microplate bottom and each well has at least one well wall and a planar well bottom having a bottom thickness of not more than 1000 μm which is aligned in a well bottom plane common to all well bottoms, wherein the method comprises:
a) providing liquefied thermoplastic material;
b) performing an injection compression molding step in an injection compression molding machine, comprising an injection unit having a conveying screw and an embossing die suitable for forming the microplate body, with introduction of a first portion of the liquefied thermoplastic material through the conveying screw into the at least partly open embossing die under a first injection pressure, closing the embossing die with exertion of a closing pressure on the thermoplastic material;
c) then performing an injection molding step with introduction of a second portion of the liquefied thermoplastic material through the conveying screw into the closed embossing die under a second injection pressure; and
d) obtaining the microplate body.

2. The method as claimed in claim 1, wherein the first injection pressure is 700 to 1100 bar.

3. The method as claimed in claim 1, wherein the second injection pressure is 200 to 700 bar.

4. The method as claimed in any of the preceding claims claim 1, wherein the closure pressure is 600 to 1000 kN.

5. The method as claimed in claim 1, wherein the thermoplastic material is stable at at least 120° C.

6. The method as claimed in claim 1, wherein the thermoplastic material is polypropylene or cycloolefin copolymer (COC).

7. The method as claimed in claim 1, wherein the thermoplastic material does not contain any thermal conductivity-enhancing medium.

8. The method as claimed in claim 1, wherein the microplate body is arranged in a frame carrier.

9. The method as claimed in claim 1, wherein a mass ratio of the first portion of the liquefied thermoplastic material to the second portion of the liquefied thermoplastic material is from 0.5 to 2.5.

10. A thermally conductive microplate made of thermoplastic material, comprising a microplate body having a microplate bottom and at least 96 wells arranged in the microplate body, wherein each well is defined by a well wall and a planar well bottom, wherein the microplate bottom is flat, all well bottoms are aligned in a well bottom plane, and the microplate body between the well bottom plane and the microplate bottom has a bottom thickness of not more than 1000 μm.

11. The thermally conductive microplate as claimed in claim 10, wherein the thermoplastic material does not contain any thermal conductivity-enhancing medium.

12. The thermally conductive microplate as claimed in claim 10, wherein the thermoplastic material is polypropylene or COC.

13. The thermally conductive microplate as claimed claim 10, wherein the microplate body is arranged in a frame carrier.

14. The thermally conductive microplate as claimed claim 10, wherein the microplate body is producible by the following method:
a. providing liquefied thermoplastic material;
b. performing an injection compression molding step in an injection compression molding machine, comprising an injection unit having a conveying screw and an embossing die suitable for forming the thermally conductive microplate body, with introduction of a first portion of the liquefied thermoplastic material through the conveying screw into the at least partly open embossing die under a first injection pressure, closing the embossing die with exertion of a closing pressure on the thermoplastic material;
c. then performing an injection molding step with introduction of a second portion of the liquefied thermoplastic material through the conveying screw into the closed embossing die under a second injection pressure; and
d. obtaining the thermally conductive microplate body.

15. The thermally conductive microplate as claimed in claim 10, wherein at least one of the microplate body and the frame carrier is opaquely colored.

16. The thermally conductive microplate as claimed in claim 10, wherein at least one of the thermally conductive microplate body and the frame carrier is opaquely colored black or white.

17. The thermally conductive microplate as claimed in claim 10, wherein the wells each have an internal volume of not more than 10 μl.

18. The thermally conductive microplate as claimed claim 10, wherein the thermally conductive microplate does not bind proteins.

19. The thermally conductive microplate as claimed in claim 10, wherein the thermally conductive microplate has a height of 2 to 5 mm.
